(19) United States
(12) Patent Application Publication
(10) Pub. No.: US 2008/0101839 A1
(43) Pub. Date: May 1, 2008

(54) Keyboard and Method for Producing a Keyboard

(76) Inventors: Arved Huebler, Chemnitz (DE); Thoralt Franz, Oelsnitz (DE); Tino Zillger, Chemnitz (DE)

Correspondence Address: STITES & HARBISON PLLC, 1199 NORTH FAIRFAX STREET, SUITE 900, ALEXANDRIA, VA, 22314, US

(21) Appl. No.: 11/813,059

(22) PCT Filed: Sep. 20, 2005
(86) PCT No.: PCT/EP05/10149

§ 371 Date: Jun. 28, 2007

(30) Foreign Application Priority Data
Jan. 17, 2005 (DE) 10 2005 002 149.2

(51) Int. Cl. B41J 5/00; H01H 13/70; H01H 13/702; H01H 11/04

(52) U.S. Cl. 400/479; 29/622

(57) ABSTRACT

The invention relates to a keyboard and to a method for producing a keyboard for activating electrical switching functions, comprising: a first substrate having a first contact structure; a second substrate having a second contact structure, and; an intermediate layer that holds both contact structures at a distance from one another and enables a contacting of both contact structures when pressure is exerted upon predetermined areas of the keyboard. Both contact structures are imprinted by means of a mass printing process.

The invention relates to a keyboard as well as a method for producing a keyboard for initiating electrical switching functions with a first substrate comprising a first electrical contact structure, a second substrate comprising a second electrical contact structure, as well as an intermediate layer which holds the two contact structures at a spacing and allows the two contact structures to contact one another at predetermined points when pressure is exerted at predetermined areas of the keyboard.

Electrical keyboards are mostly known in constructions in which individual keys mounted in a mobile manner close or open an electrical contact mechanically. Also known are so-called membrane keyboards in the case of which electrical contact is established as a result of the two membranes lying on top of one another in each case with an electrical contact structure, frequently in a matrix arrangement, with a spacing between the two membranes being maintained by an insulating intermediate layer. Recesses are punched out in the intermediate layer, so that electrical contact between the two conductors of the outer membranes is produced at these points under external pressure. The conductive structures on the outer membrane sheets are currently produced from copper by electrodeposition or by the vapor deposition of metal or by etching processes on a membrane with a metal surface.

On account of the dissimilarity of the processes, only a slow and unlinked production is possible today.

A keyboard membrane circuit in the case of which the conductor tracks are produced by means of screen printing of silver conductive pastes is known from DE-C-34 34 664.

U.S. Pat. No. 6,043,441 discloses a membrane switch whose electrical contacts are applied to a top and a bottom membrane by means of silver conductive paste, with an insulating paste being applied between the two membranes.

The object of the invention is therefore to indicate a keyboard as well as a method for producing the latter which is distinguished by considerably more favorable costs.

This object is solved according to the invention by the features of claims 1 and 8.

The keyboard according to the invention for initiating electrical functions consists essentially of a first substrate comprising a first electrical contact structure, a second substrate comprising a second electrical contact structure, as well as an intermediate layer which holds the two contact structures at a spacing and allows the two contact structures to contact one another when pressure is exerted at predetermined areas of the keyboard. The two contact structures are in this case imprinted by means of a mass printing method.

Further configurations of the invention constitute the subject matter of the subclaims.

According to one preferred embodiment, the intermediate layer is an adhesive layer which is expediently applied in a partial manner, with the areas where contact of the two contact structures is guaranteed when pressure is exerted at the predetermined areas being recessed.

The electrical contact structures advantageously consist of conductive polymers. When the keyboard is produced the two contact structures and/or the intermediate layer are/is applied by means of mass printing methods, such as, for example, planographic printing, relief printing or intaglio printing. It is in this respect of particular advantage for the intermediate layer to be applied as an adhesive layer, in which case the adhesive layer joins the two substrates firmly together.

The electrical contact structures are preferably imprinted by means of the method which is described in DE-A-10 2004 058 209, in which the substrate or the material sheet is pretreated by means of a corona treatment, for example.

In one configuration of the invention the intermediate layer is a substrate, in particular of paper or film.

According to one particularly advantageous embodiment, the first substrate, the second substrate and the intermediate layer are formed by a common flexible material sheet. The first substrate, the second substrate and the intermediate layer are disposed one on top of the other, with the intermediate layer being recessed at the predetermined areas in order to guarantee contact of the two contact structures.

When the keyboard is produced a common flexible material sheet is expediently used for the first substrate, the second substrate and the intermediate layer, with the material sheet expediently being punched out in the area of the intermediate layer at the predetermined areas in order to guarantee contact of the two contact structures and the material sheet being folded such that the intermediate layer is located between the first and the second substrate.

Further configurations and advantages of the invention are illustrated in detail in the following on the basis of the description of several embodiments and the drawings.

### IN THE DRAWINGS

FIG. 1 is a three-dimensional view of the composition of the keyboard,

FIG. 2 is a sectional representation of the keyboard,

FIG. 3 is a schematic representation of the procedural sequence when producing the keyboard according to a first embodiment,

FIGS. 4a and 4b are schematic representations of different possibilities when printing the keyboard and

FIGS. 5a and 5b are each a schematic representation of the procedural sequence when producing the keyboard according to a second embodiment.

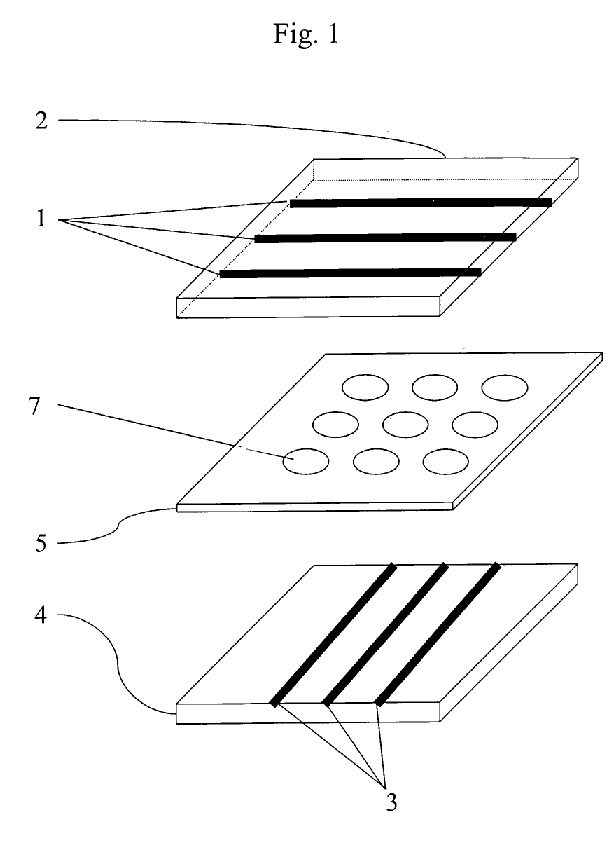

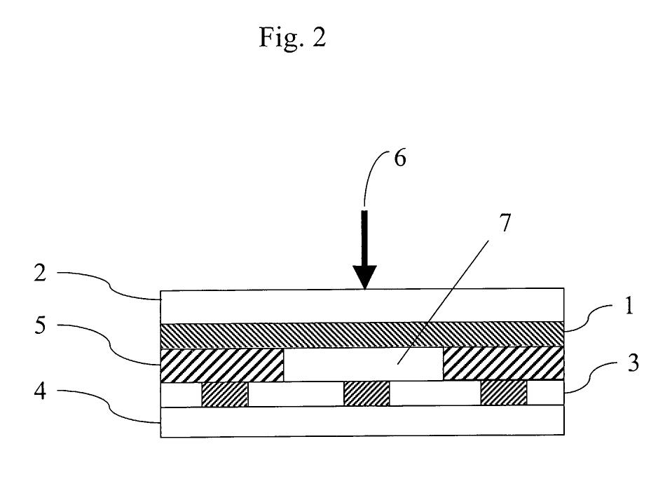

The composition of the keyboard for initiating electrical switching functions is firstly illustrated in detail in the following on the basis of FIG. 1 and FIG. 2. The keyboard consists essentially of a first substrate 2 comprising a first electrical contact structure 1, a second substrate 4 comprising a second electrical contact structure 3, as well as an intermediate layer 5 which holds the two contact structures at a spacing and allows the two contact structures to contact one another when pressure is exerted (arrow 6) at predetermined areas of the keyboard.

The intermediate layer 5 is formed, for example, by an adhesive layer which is applied in a partial manner and recessed where contact of the two contact structures is to be guaranteed when pressure is exerted (arrow 6) at the predetermined areas of the keyboard. These recesses are marked by the reference number 7 in the drawings.

In principle all possible insulating and flexible materials, such as, for instance, films or paper, can be considered for the two substrates 2, 4. Conductive materials, such as, for example, inorganic systems (carbon black) adapted to the printing methods or, in particular, conductive polymers, such as PEDOT-PSS, PANi or similar, are used for the contact structures 1, 3.

According to the invention, the production of the keyboard is rendered considerably simpler and cheaper by imprinting the contact structures by means of a mass printing method (such as planographic printing, relief printing, intaglio printing, offset printing, flexography). The intermediate layer, which is an adhesive layer, for example, can also be applied by means of a mass printing method or according to the “inkjet printing” principle. However the intermediate layer may also be applied in another way, in particular through spraying. It is also conceivable for the intermediate layer to be a substrate, for example of paper or film.

If the intermediate layer is an adhesive layer, the two substrates 2, 4 are joined together in a partial and non-positive manner.

The intermediate layer also serves at the same time as an insulator and, on account of its layer thickness, guarantees an appropriate spacing between the two substrates. The recesses 7 in the intermediate layer 5 are formed such that the electrical contact structures 1 and 3 do not contact one another and therefore do not establish electrical contact without an external load, although come into contact and then establish electrically conductive contact when pressure is exerted externally (arrow 6) on account of the plastic deformation of the overall structure which occurs.

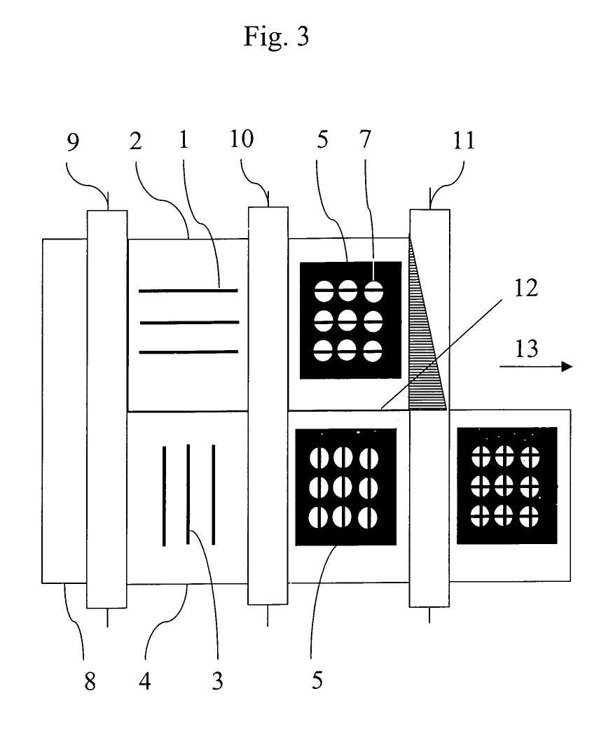

When the keyboard is produced (see FIG. 3) the two substrates 2, 4 are expediently made from a common flexible material 8, which may consist of a film or paper. In a first working step the first and the second electrical contact structure 1, 3 are imprinted on the material sheet 8 by means of a printing roller 9, for example. In the next step the intermediate layer 5 is printed over the contact structures by means of a printing roller 10. However it may in this respect be sufficient for the intermediate layer only to be applied over one of the two contact structures. In the third step the material sheet 8 is folded about a folding edge 12 by means of a folding device 11 such that the first contact structure with the intermediate layer is folded onto the second contact structure, which results in the composition which is represented in FIG. 2. Finally, just the cutting operation is then carried out in order to obtain the individual keyboards.

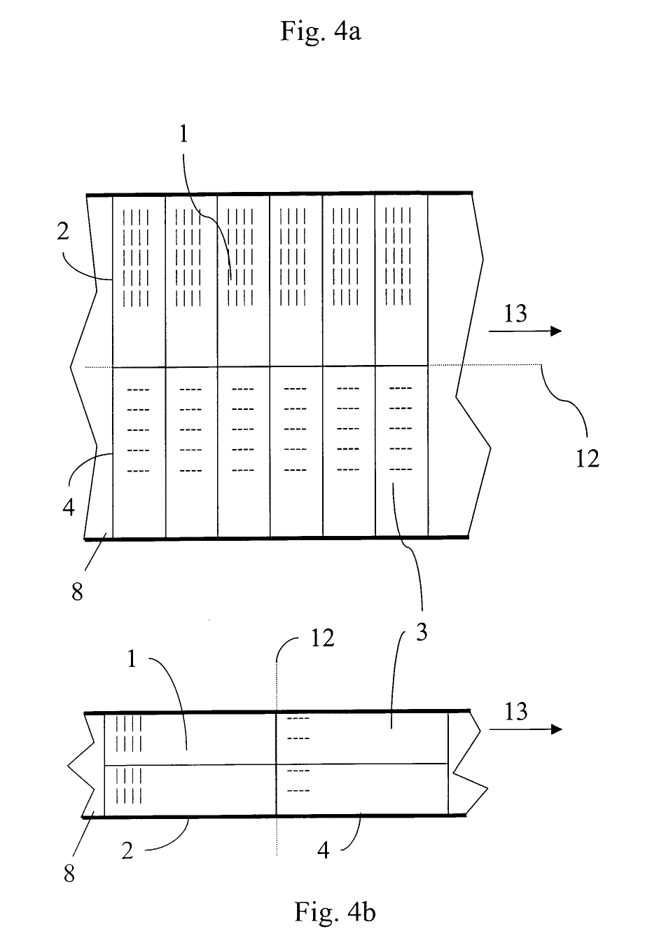

FIGS. 4a and 4b show embodiments as to how the two contact structures 1 and 3 can be imprinted on the common material sheet 8 in relation to the transport direction 13 of the material sheet.

In the embodiment according to FIG. 4a both contact structures are printed at the same time, so that the subsequent folding edge 12 extends in the printing direction 13. However in the second embodiment according to FIG. 4b the contact structures 1, 3 are printed in succession, so that the subsequent folding edge 12 extends transversely to the transport direction 13 of the material sheet 8.

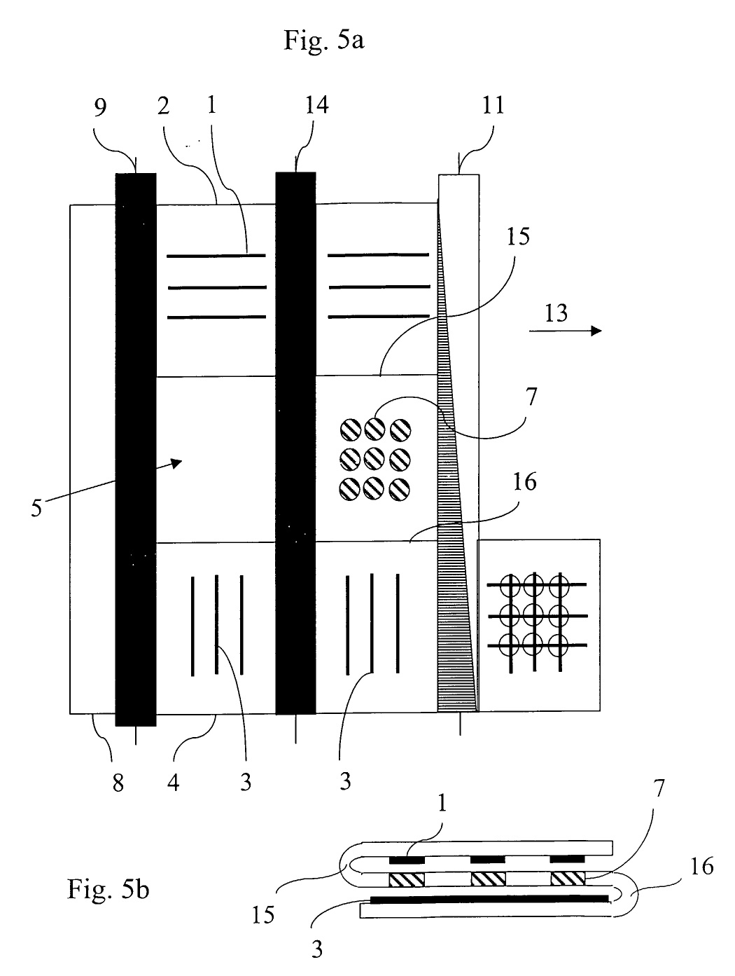

FIGS. 5a and 5b show a second production method in which a common flexible material sheet 8 is used for the first substrate 2, the second substrate 4 and the intermediate layer 5. In a first working step the first and the second electrical contact structure 1, 3 are imprinted on the material sheet 8 by means of a printing roller 9, for example. In the next working step the material sheet is provided at the predetermined areas with perforations 7 in the area of the intermediate layer 5 by means of a punching tool 14, which recesses subsequently guarantee contact of the two contact structures when pressure is exerted.

In the third step the material sheet 8 is folded about folding edges 15, 16 according to FIG. 5b by means of a folding device 11, with the intermediate layer coming to lie between the first and the second substrate. Any adhesive layer applied beforehand can hold the composite structure together for a long time.

The individual layers may cohere for a long time or be separated from one another by a cutting operation.

The use of conventional printing and folding technology enables keyboards to be mass-produced extremely cheaply.

1. Keyboard for initiating electrical switching functions with a first substrate (2) comprising a first electrical contact structure (1), a second substrate (4) comprising a second electrical contact structure (3), as well as an intermediate layer (5) which holds the two contact structures at a spacing and allows the two contact structures to contact one another when pressure is exerted (6) at predetermined areas of the keyboard, characterized in that the two contact structures are imprinted by means of a relief printing, intaglio printing or planographic printing method.

2. Keyboard according to claim 1, characterised in that the intermediate layer (5) is an adhesive layer.

3. Keyboard according to claim 1, characterised in that the first and the second substrate (2, 4) are formed by a common flexible material sheet (8).

4. Keyboard according to claim 1, characterised in that the intermediate layer (5) is a substrate, in particular of paper or film.

5. Keyboard according to claim 1, characterised in that the first substrate (2), the second substrate (4) and the intermediate layer (5) are formed by a common flexible material sheet (8) and are disposed one on top of the other, wherein the intermediate layer (5) is recessed at the predetermined areas in order to guarantee contact of the two contact structures (1, 3).

6. Keyboard according to claim 1, characterised in that the intermediate layer (5) is applied in a partial manner, wherein the areas where contact of the two contact structures (1, 3) is guaranteed when pressure is exerted at the predetermined areas of the keyboard are recessed.

7. Keyboard according to claim 1, characterised in that the electrical contact structures (1, 3) consist of conductive polymers.

8. Method for producing a keyboard for initiating electrical switching functions with a first substrate (2) comprising a first electrical contact structure (1), a second substrate (4) comprising a second electrical contact structure (3), as well as an intermediate layer (5) which holds the two contact structures at a spacing and allows the two contact structures to contact one another at predetermined points when pressure is exerted (6) at predetermined areas of the keyboard, characterized in that the two contact structures are imprinted by means of a relief printing, intaglio printing or planographic printing method.

9. Method according to claim 8, characterised in that the intermediate layer (5) is imprinted.

10. Method according to claim 8, characterised in that the intermediate layer (5) is applied as an adhesive layer, wherein the adhesive layer joins the two substrates (2, 4) firmly together.

11. Method according to claim 6, characterised in that the two contact structures (1, 3) are firstly imprinted on a common material sheet (8), the intermediate layer is then applied in the area at least of one of the two contact structures and the two contact structures with the intermediate layer are folded on top of one another.

12. Method according to claim 6, characterised in that a common flexible material sheet (8) is used for the first substrate (2), the second substrate (4) and the intermediate layer (5).

13. Method according to claim 6, characterised in that a common flexible material sheet (8) is used for the first substrate (2), the second substrate (4) and the intermediate layer (5), the material sheet is punched out in the area of the intermediate layer at the predetermined areas in order to guarantee contact of the two contact structures (1, 3) and the material sheet is folded such that the intermediate layer is located between the first and the second substrate.
